(19) United States
(12) Patent Application Publication
(10) Pub. No.: US 2008/0247025 A1
(43) Pub. Date: Oct. 9, 2008

(54) Optical system for a wash light

(75) Inventor: Pavel Jurik, Postredni Becva (CZ)

Correspondence Address: HEINZ GRETHER PC;G2 Technology Law, P.O. Box 40610, AUSTIN, TX, 78704, US

(73) Assignee: ROBE SHOW LIGHTING S.R.O.

(21) Appl. No.: 12/075,467

(22) Filed: Mar. 11, 2008

(30) Foreign Application Priority Data
Mar. 3, 2006 (CZ) PCT/CZ2006/000011

(51) Int. Cl. G02B 26/08

(52) U.S. Cl. 359/234

(57) ABSTRACT

The present invention generally relates to an optical system for a wash light and specifically to a variable beam angle system which provides an improved range of beam angles and efficient light output. The present invention includes a light modulating optical element that has a central aperture that can be moved along the optical axis the system. Further the central aperture of the modulating element may be occluded by a diffusing element. The extent of the occlusion can be varied. At a first limit position when the optical system is adjusted so as to provide the minimum beam divergence the light beam will pass through the aperture with no intensity loss. In this configuration the first optical element has practically no effect on the beam. At a second limit position when the optical system is adjusted so as to provide the maximum beam divergence the diffusers cover the central aperture to diffuse the central illumination so as to avoid excessive intensity in the beam centre. The range of beam angles and light modulation can be further improved by means of a variable sized aperature.

### RELATED APPLICATION

This application is a continuation in part application of application Ser. No. ______ (not yet assigned) filled on Mar. 11, 2008 which is a National Phase application of PCT Application Number PCT/CZ2006/000011 filed on Mar. 3, 2007.

### TECHNICAL FIELD OF THE INVENTION

The present invention generally relates to optical systems. More specifically optical systems in a light beam producing luminaire, particularly for a wash light and even more specifically to a variable beam angle wash light system which provides an improved range of beam angles and efficient light output.

### BACKGROUND OF THE INVENTION

Luminaires used in the entertainment industry such as those commonly used in theatres, television studios, concerts, theme parks, night clubs and other venues can typically be broadly categorized into two main categories each with differing optical properties. The two categories are imaging and non-imaging. The imaging type (commonly known as spot lights) are designed to project a focused image of a pattern or stencil or are provided with a shutter system to allow sharp cut-off of the light to stop it impinging on a curtain or other areas of the stage. They are also often used to provide accent lighting to a well defined area of the scene. The non-imaging type typically produces a soft-edged diffuse beam often used for general illumination and to provide background lighting and color. The present invention is concerned with the latter non-imaging category, often known as wash lights.

It is advantageous in such a system to provide a broad range of beam angles from a single fixture. Various optical systems are well known in the prior art for providing this beam angle control; however, they all suffer from various disadvantages and concerns. A very common system uses a spherical reflector with a light source mounted at the optical centre of the reflector. The combination of the direct and reflected light is passed through a single positive lens. The separation between the light source/reflector combination and the lens is variable to control the divergence of the output beam. Such systems are capable of a large range of adjustment of the output beam angle but are highly inefficient systems, particularly at narrow beam angles where much of the light from the light source and reflector completely misses the output lens.

Improvements to this system with higher efficiency can be effected by using an ellipsoidal reflector and a more complex lens. Such a system is described in U.S. Pat. 6,899,451 to Kittelmann et al. however the beam produced by this system is prone to having a very high intensity in the centre, often known as a hot-spot, which is undesirable for many uses.

A further prior art system is disclosed in U.S. Pat. No. 5,515,254 to Smith et al. Here the beam angle divergence is controlled through the use of an iris or variable sized aperture. As should be apparent such a system provides significantly reduced output at narrow beam angles as much of the light is blocked or vignetted by the iris.

A yet further prior art system is disclosed in U.S. Pat. No. 6,282,027 to Hough which suggests using an ellipsoidal reflector and a pair of matched lenses, one with positive focal length and one with negative focal length to change the beam divergence. As with the systems above this produces an undesirable high intensity in the beam centre, or hot-spot particularly when used at narrow beam divergence. In addition the use of two lenses rather than one reduces the overall efficiency of the system.

Consequently there is a need for a system which can provide a large range of controllable beam divergence while retaining efficiency and avoiding hot-spots in the beam centre.

### SUMMARY OF INVENTION

The present invention generally relates to an optical system for a wash light and specifically to a variable beam angle system which provides an improved range of beam angles and efficient light output.

In one embodiment the present invention includes two optical elements whose spacing may be varied. The first optical element has a central aperture which may be occluded by a diffusing element. The extent of the occlusion of the central aperture is coupled to the mechanism for changing the separation of the optical elements. In a preferred embodiment the second optical element remains fixed while the first optical element and its associated diffusing element are linked and move as a pair to adjust the separation between the two optical elements.

Further, the diffusion element comprises two semicircular diffusers each attached to pivot arms such that in a first limit position the semicircular diffusers are completely outside the aperture in the first optical element and in a second limit position the semicircular diffusers completely occlude the aperture in the first optical element. The semicircular diffusers may be frosted glass.

At a first limit position when the optical system is adjusted so as to provide the minimum beam divergence and the first and second optical elements are maximally separated the semicircular diffusers are completely outside the aperture in the first optical element and the light beam will pass through the aperture with no intensity loss. In this configuration the first optical element has practically no effect on the beam. At a second limit position when the optical system is adjusted so as to provide the maximum beam divergence and the first and second optical elements are minimally separated the semicircular diffusers completely occlude the aperture in the first optical element and thus diffuse the central illumination so as to avoid excessive intensity in the beam centre.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a plan optical axis view of an embodiment of the present invention configured for minimum beam divergence;

FIG. 2 illustrates a plan optical axis view of an embodiment of the present invention configured for maximum beam divergence;

FIG. 3 illustrates a perspective view of a first optical element and a diffusing elements in a first limit configuration;

FIG. 4 illustrates a perspective view of the first optical element and the diffusing element in a second limit configuration;

FIG. 5 illustrates a diagram of an exemplar coupling relationship between the movement of the optical elements and the closing configuration of the diffusing elements;

FIG. 6 illustrates a further diagram of the coupling relationship between the movement of the optical elements, the closing of the diffusing elements and the opening of the opaque iris aperture;

FIG. 7 illustrates a plan optical axis view of an alternative embodiment of the present invention positioned for minimum beam divergence; and

FIG. 8 illustrates a plan optical axis view of an alternative embodiment of the

### DETAILED DESCRIPTION OF THE INVENTION

Preferred embodiments of the present invention are illustrated in the FIGUREs, like numerals being used to refer to like and corresponding parts of the various drawings.

The present invention generally relates to an optical system for a luminaire for producing a light beam. The optical system is particularly used for a category of luminaire known as a wash light and specifically to a variable beam angle wash light which provides an improved range of beam angles balanced with size and efficient light output.

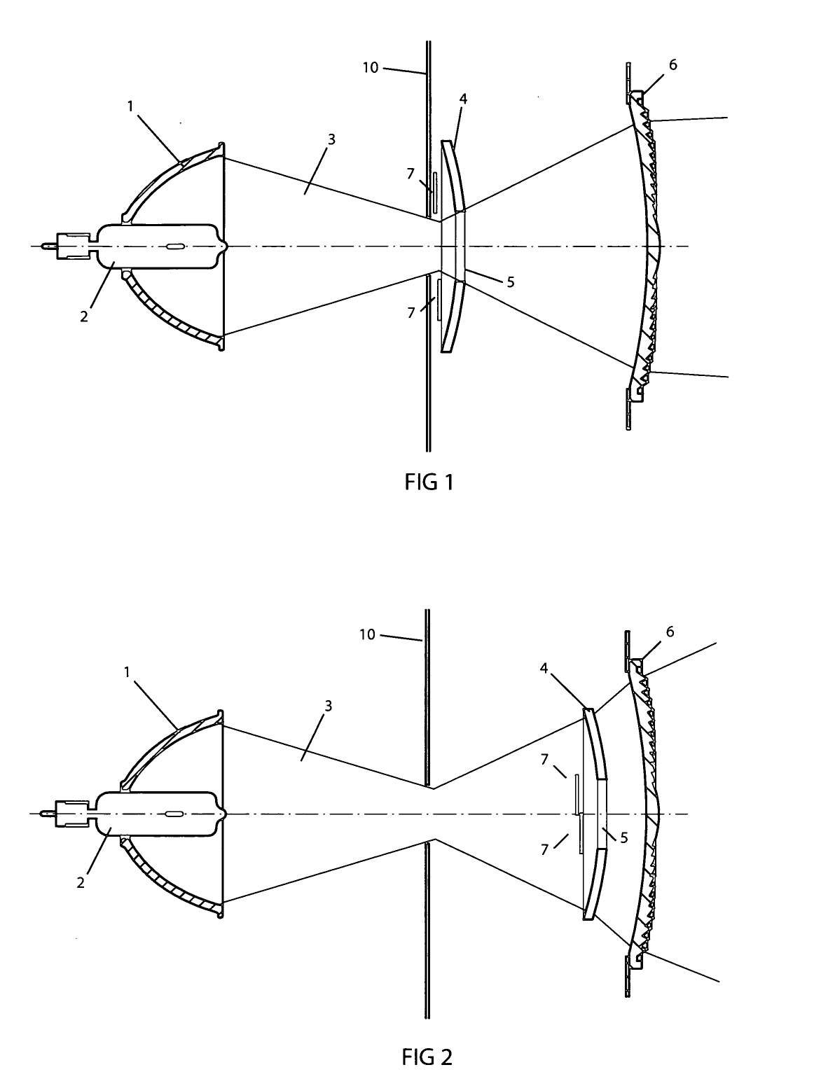

FIG. 1 illustrates a plan view along the optical axis of the optical path of an embodiment of the present invention. In FIG. 1 the optical elements are shown in a configuration which provides for minimum beam divergence (a narrow beam angle). The embodiment illustrated in FIG. 1, including the lamp, employs the use of six optical elements. The first element, a lamp 2, provides the light source which is positioned close to the first focus of elliptical reflector 1, the second optical element so as to produce a light beam 3. The light beam 3 will converge towards the second focus of the elliptical reflector down the optical axis. Persons skilled in the art will appreciate that alternative embodiments may employ other elements to generate a generally focused light beam.

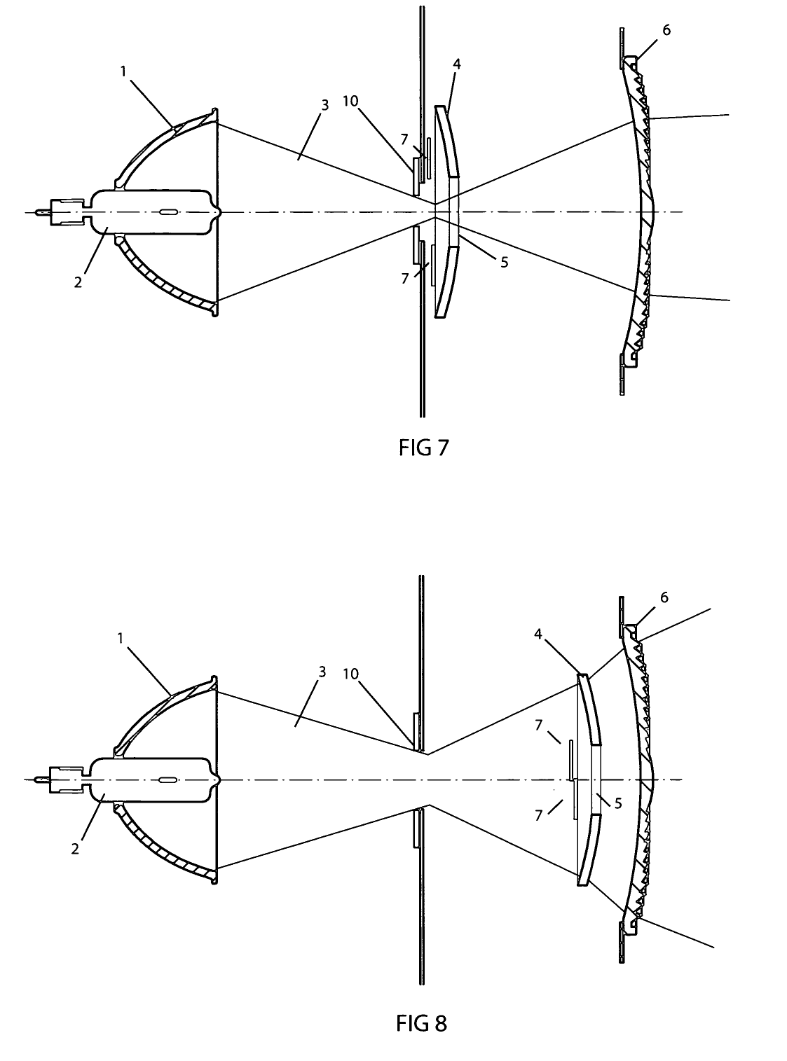

The third optical element, an opaque aperture plate 10, is positioned adjacent to the second focus of elliptical reflector 1. The plate is opaque so as to provide a controlled light beam by eliminating spill or stray light. At the second focus position the diameter of light beam 3 will be at a minimum. In one embodiment upon which the illustration of FIG. 1 is based this diameter is between 30 mm and 50 mm. In an alternative embodiment illustrated in FIG. 7 and FIG. 8 the opaque aperture plate may be articulatable so that it varies the size and or shape of the aperture. In the embodiment illustrated in FIG. 7 and FIG. 8 a variable diameter iris with a circular aperture is employed. However in alternative embodiments other variable shape or size mechanism may also be employed.

With the system configured for minimum beam divergence the fourth optical element 7 and fifth optical element 4 are configured adjacent to the opaque aperture 10 in a rear limit position close to the second focus of reflector 1. The fourth optical element is a variable diffuser 7 described in greater detail below. In the rear, minimal beam divergence configuration the variable diffuser is not in the path of the light beam 3.

The fifth optical element 4 may be formed of a positive or negative lens, a fresnel lens. Diffusion glass a lenticular lens or other lens type known in the art to modulate the beam angle of the light beam passing through the opaque aperture plate 10. The fifth optical element and the sixth optical element acting together may form a two element zoom lens system where the beam angle of the resultant output beam is controlled by the separation of the fifth and sixth optical elements. In addition, the fifth optical element 4 has a central aperture 5. In the embodiment shown the size of this aperture 5 is chosen such that when the optical element is in the rear limit position and close to the second focus of reflector 1 light beam 3 will pass through aperture 5 in the fifth optical element 4 with no intensity loss or change of beam divergence.

In the embodiment illustrated the diffusing element is comprised of two semicircular diffusers 7. Which are configured to the rear of the fifth optical element 4.

After passing through the aperture 5 in the fifth optical element 4 light beam 3 will impinge on the sixth optical element 6 which will modulate light beam 3 to form the output beam. In the configuration and positioning shown in FIG. 1 where the fifth optical element 4 is at its rear, first, limit position and the spacing between the fifth optical element 4 and the sixth optical element 6 is maximal the output beam will be of minimal divergence. In this embodiment sixth optical element 6 is a positive fresnel lens however the invention is not so limited and in further embodiments sixth optical element 6 may be either a positive or negative lens and may be plano convex, bi-convex, plano-concave, bi-concave, concave-convex or other lens shapes intended to modulate beam angle.

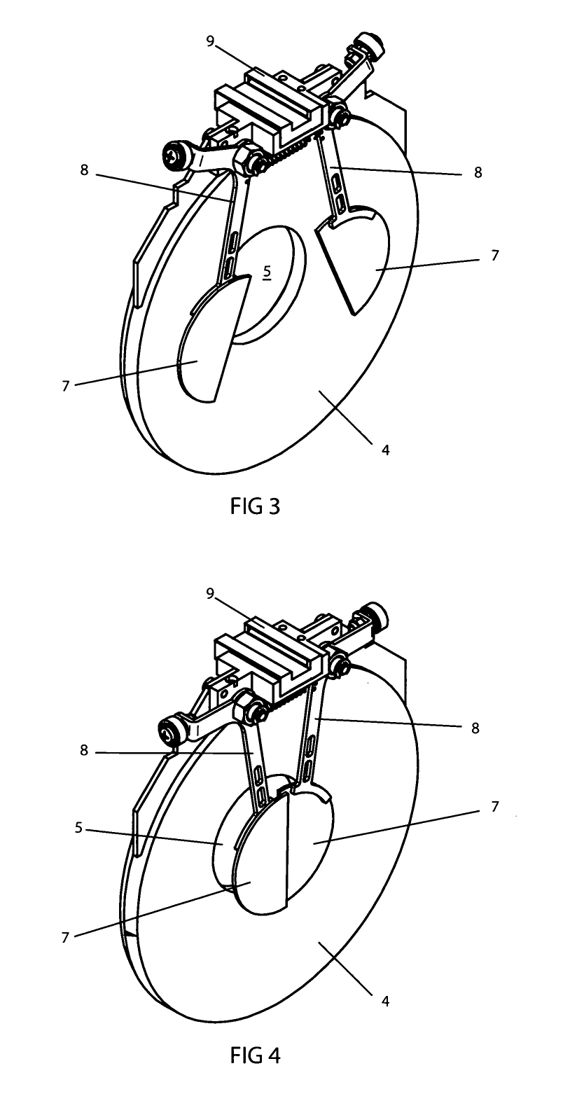

FIG. 2 illustrates a plan view along the optical axis of the optical path of an embodiment of the present invention positioned for maximum beam divergence. As in FIG. 1 light source 2 is positioned close to the first focus of elliptical reflector 1 so as to produce a light beam 3. The light beam 3 will converge towards the second focus of the elliptical reflector. An opaque aperture plate 10 is positioned adjacent to the second focus of reflector 1 to provide a controlled light beam by eliminating spill or stray light. At the second focus position the diameter of light beam 3 will be at a minimum. With the system configured for maximum beam divergence the fifth optical element 4 is positioned in the forward limit position such that optical element 4 is distant from the second focus of reflector 1 and closer to the sixth optical element 6.

In this configuration, the fourth optical element 7 is engages the light beam. The diffuser 7 may be glass, plastic or other material known in the art and may be translucent, frosted or etched and may further contain prismatic or lenticular diffusion as known in the art. In a further embodiment the semicircular diffusers 7 may be a bisected simple or fresnel lens. They may be a single piece or multiple pieces.

The diffusing element illustrated in the figures is comprising two semicircular diffusers 7 which enter the light beam 3 from opposite sides. Thought not shown, in this embodiment, the diffuser and fifth optical element are mounted to the same carrier and travel along the light beam axis together. In the embodiment shown the diffuser 7 is mounted to the rear of the fifth optical element 4. In other embodiments the diffuser may be mounted past the fifth optical element 4 along the optical axis. f. In the second limit position as shown in FIG. 2 the semicircular diffusers completely occlude the aperture 5 in the first optical element 4 and modulate the centre portion of light beam 3.

After passing through the opaque aperture plate 10 light beam 3 will impinge on the fifth optical element 4 and the diffusion element 7 whence light beam 3 will be diffused and refracted before impinging on sixth optical element 6 which will modulate the light beam 3 to form the output beam. In the configuration and positioning shown in FIG. 2 where the fifth optical element 4 is at its front, second, limit position and the spacing between the fifth optical element 4 and the sixth optical element 6 is minimal the output beam will be of maximal divergence. The central region of illumination will be controlled by the diffusing element 7 so as to avoid excessive intensity in the output beam centre.

In a preferred embodiment the sixth optical element remains fixed while the first optical element and its associated diffusing element are linked and move as a pair to adjust the separation between the forth and fifth optical elements and the sixth optical elements.

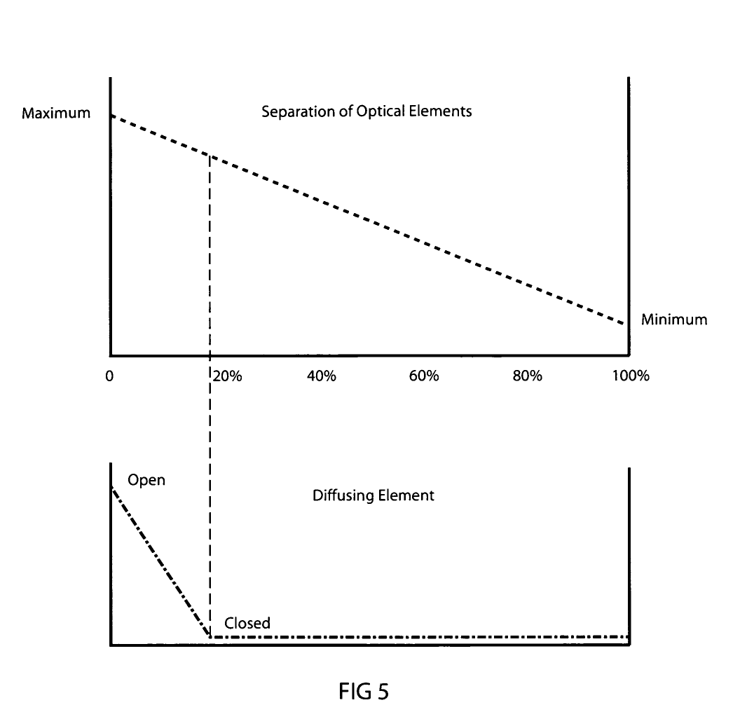

The extent of the occlusion of the central aperture is coupled to the mechanism for changing the separation of the optical elements. In the zoom process as the system moves from minimum beam divergence towards maximum beam divergence the fifth optical element 4 moves toward the sixth optical element 6 while simultaneously the semicircular diffusers 7 start to close. The movement of the semicircular diffusers 7 is coupled with the movement of the fifth optical element 4 such that, during approximately the first 20% of the movement of the fifth optical element 4, both semicircular diffusers 7 are moved from their first limit position, when they are outside the central aperture 5, to their second limit position, gradually closing together until the central aperture 5 of the fifth element 4 is completely occluded. The closed position of semicircular diffusers 7, shown in FIG. 2 and FIG. 4, remains unchanged during the remaining movement of the fifth optical element 4 towards the fixed position of the sixth optical element 6. FIG. 5 illustrates the coupling relationship between the movement of the optical elements and the closing of the diffusing elements.

FIGS. 3 and FIG. 4 show the fifth optical element 4 and connected diffusion elements 7 in their two limit positions.

In FIG. 3 the semicircular diffusers 7 are shown in their fully open first limit position such that they are outside the aperture 5 in fifth optical element 4. Each of the two semicircular diffusers 7 are attached to pivot arms 8 which in turn are pivotally coupled to the lens carrier 9 which supports the fifth optical element 4.

In FIG. 4 the semicircular diffusers 7 are shown in their fully closed second limit position such that they completely occlude the aperture 5 in fifth optical element 4.

The mechanical coupling of the semicircular diffusers and pivot arms 8 with the movement of fifth optical element 4 is provided through means well known in the art.

FIG. 7 illustrates an embodiment the optical train of a luminaire where the opaque aperture plate 10 may be varied in size to further enhance the range of beam divergence angles available to the user. In this embodiment an additional step is provided in the sequence. With the system as shown in FIG. 1 where the diffusing elements and optical elements positioned so as to produce the minimum beam divergence from those elements the variable size aperture plate 10 may be reduced in size to further reduce the beam divergence.

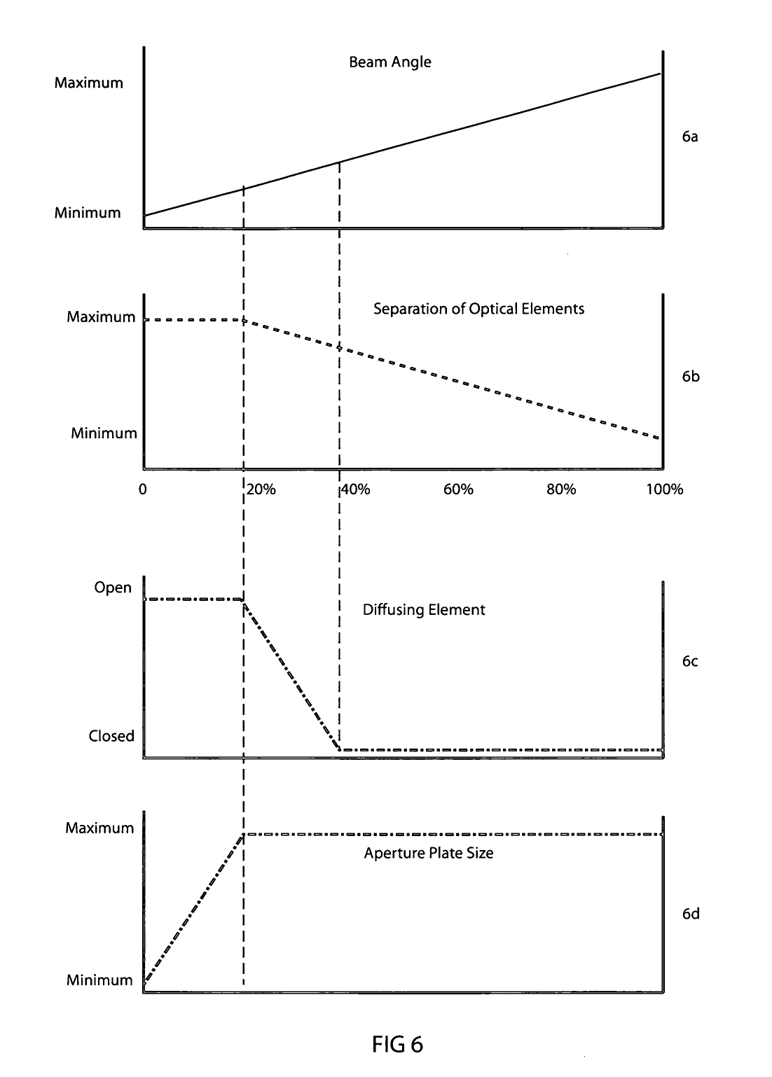

FIG. 6 illustrates the coupling relationship between the movement of the optical elements the closing of the diffusing elements and the change in size of the aperture plate 10 so as to provide a large range of beam divergence adjustment. Referring to FIG. 6, the minimum beam angle FIG. 6a of the system is achieved on the left side of the charts. This is when the optical elements 4 and 6 (shown in FIG. 6b) are maximally separated, the diffusing elements 7 (shown in FIG. 6c) are open and the aperture plate 10 size (shown in FIG. 6d) is at a minimum. This minimum angle configuration is illustrated in FIG. 7.

The first stage in increasing beam angle is to open the aperture plate 10 (shown in FIG. 6d) while keeping the diffusing elements 7 and optical elements 4 and 6 static. When the aperture plate 10 has reached its maximum size then the diffusing elements 7 may start to close and the separation of the optical elements 4 and 6 reduced. The diffusing elements 7 may reach their fully closed position before the optical elements 4 and 6 are minimally separated, in this case the optical elements 4 and 6 will continue to move closer together while all other elements are static.

The final maximum beam angle will be achieved on the right hand side of the charts shown in FIG. 6 when the optical elements 4 and 6 (shown in FIG. 6b) are minimally separated, the diffusing elements 7 (shown in FIG. 6c) are closed and the aperture plate 10 size (shown in FIG. 6d) is at a maximum. This maximum angle configuration is illustrated in FIG. 8.

In the embodiment described above the movement of the optical elements and diffusers are coupled either mechanically, electrically or through software and may be controlled by a single master control signal. However such coupling is not required and, in further embodiments of the invention, the movements of the individual optical elements and the diffusers are mechanically and electrically uncoupled from each other and may be individually controlled. Such decoupling allows the user to obtain useful results and beam profiles

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims.

What is claimed is:

1. Optical system having at least two optical elements with a variable mutual position, characterized in, that the first optical element has central hole and a translucent screen moveable with respect to the central hole, the position of the screen with respect to the central hole being coupled with a mechanism for a change of the mutual position of the optical elements.

2. Optical system according to claim 1, characterized in, that the first optical element is moveable with respect to the second optical element.

3. Optical system according to claim 1, characterized in, that the position of the screen with respect to the first optical element system is fixed

4. Optical system according to claim 2, characterized in, that the position of the screen with respect to the first optical element system is fixed

5. Optical system according to claim 1, characterized in, that the screen consists of two semicircles, the semicircles covering the screen central hole while in the first limit position and being outside the screen central hole while in the second limit position.

6. Optical system according to claim 2, characterized in, that the screen consists of two semicircles, the semicircles covering the screen central hole while in the first limit position and being outside the screen central hole while in the second limit position.

7. Optical system according to claim 3, characterized in, that the screen consists of two semicircles, the semicircles covering the screen central hole while in the first limit position and being outside the screen central hole while in the second limit position.

8. Optical system according to claim 4, characterized in, that the screen consists of two semicircles, the semicircles covering the screen central hole while in the first limit position and being outside the screen central hole while in the second limit position.

9. Optical system according to claim 1, characterized in, that the screen is made of a frosted glass.

10. Optical system according to claim 2, characterized in, that the screen is made of a frosted glass.

11. Optical system according to claim 3, characterized in, that the screen is made of a frosted glass.

12. Optical system according to claim 4, characterized in, that the screen is made of a frosted glass.

13. Optical system according to claim 5, characterized in, that the screen is made of a frosted glass.

14. Optical system according to claim 6, characterized in, that the screen is made of a frosted glass.

15. Optical system according to claim 7, characterized in, that the screen is made of a frosted glass.

16. Optical system according to claim 8, characterized in, that the screen is made of a frosted glass.
